(19) United States
(12) Patent Application Publication
(10) Pub. No.: US 2012/0069105 A1
(43) Pub. Date: Mar. 22, 2012

(54) INK TANK

(76) Inventors: Thomas Elste, Meersbusch (DE); Ingo Kreidl, Krefeld (DE)

(21) Appl. No.: 13/138,149

(22) PCT Filed: Aug. 25, 2009
(86) PCT No.: PCT/EP2009/060931

§ 371 Date: Dec. 2, 2011

(30) Foreign Application Priority Data
Jan. 13, 2009 (EP) 09150436.5

(51) Int. Cl. B41J 2/175

(52) U.S. Cl. 347/86

(57) ABSTRACT

The present invention relates to an ink tank (10), in particular for a printing head of an inkjet printer, having an ink chamber (11) for the uptake of ink (12) the chamber having a removal opening (14) for the ink (12), having an element (20) for slowing down the outflow of ink provided in the region of the removal opening (14) and forming an ink outlet (23) at least in regions, having a tank element (30), which is provided inside the ink chamber (11), the inside space (38) thereof being connected to the ink chamber (11) by means of at least one transfer opening (36) and in which a porous material is provided, and having a ventilation device for the tank element (30). In order to create an ink tank in which the ink chamber can be filled with the maximum amount of ink, whereby an undesired overflow of the ink can simultaneously be prevented, it is provided according to the invention that at least the ink outlet (23) formed by the element (20) for slowing down the outflow of ink is provided at a distance from the removal opening (14) within the ink chamber (11), that the tank element (30) is disposed at least around the ink outlet (23) formed by the element (20) for slowing down the outflow of ink, that the porous material (40) is applied at least at the ink outlet (23) formed by the element (20) for slowing down the outflow of ink, and that the transfer point (37) of ink from the ink chamber (11) into the tank element (30) is provided under the ink outlet (23) formed by the element (20) for slowing down the outflow of ink.

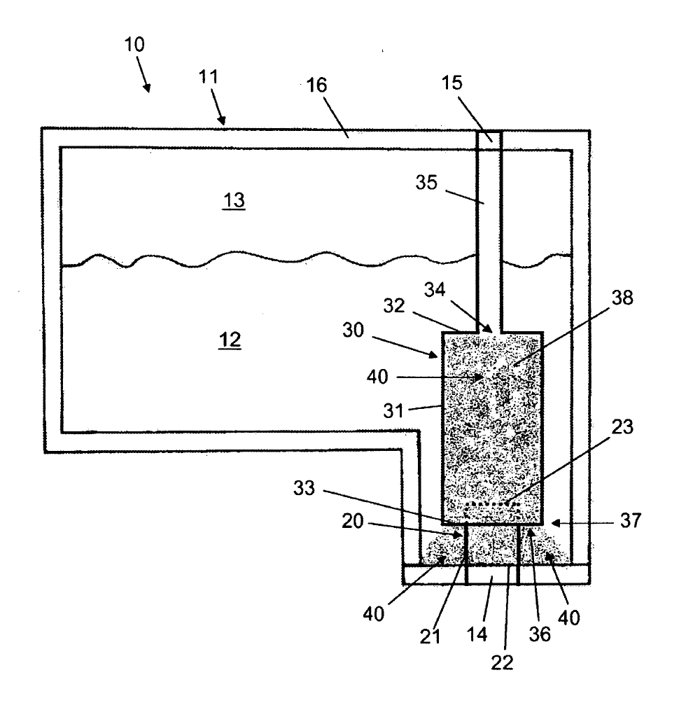

The present invention relates to an ink tank, in particular for a printing head of an inkjet printer, according to the preamble of patent claim 1.

In order to fill ink tanks or ink cartridges with the highest possible quantity of ink, the enclosed space of the ink cartridge must be kept as free as possible for the uptake of the ink fluid.

The greatest recycling benefit will be achieved by an underpressure cartridge. This generally involves a system for the targeted delivery of suitably large quantities of ink, in which the ink in the system is prevented from flowing out too much due to the pressure ratios. Another cartridge type involves a so-called sponge cartridge. A sponge cartridge is generally a system for the targeted delivery of suitably large ink quantities, in which the ink in the system is prevented from flowing out too much by means of a porous element filling the space, for example a sponge unit. The sponge unit is suitable for taking up ink and delivering it again in suitable doses. However, the sponge unit occupies a volume that cannot be used for filling with ink.

It is thus desirable to combine the advantages that an underpressure system can offer, i.e., a large space for the ink to be stored, with the advantages of a sponge system.

In this respect, different solutions are already known in the prior art. For example, an ink tank is disclosed in DE 196 03 195 A1, which is particularly suitable for a printing head of an inkjet printer. For the direct uptake of ink, the ink tank first of all provides an ink chamber that has a removal opening for the ink. In addition, an element is provided for slowing down the outflow of ink, the element being in the form of a sieve that is provided in the region of the removal opening in the ink chamber and that thus forms an ink outlet. The known ink tank also has another tank element that is provided inside the ink chamber above the removal opening. In order to be able to utilize the phenomenon of underpressure, this tank element is connected to the ink chamber by means of at least one transfer opening. In addition, for the purpose of generating a capillary effect in the tank element, a porous material is provided, wherein the tank element is additionally provided with or combined with a ventilation device. Other, but similar solutions are described in DE 43 28 001 C2 or EP 0 580 433 A1. The known solutions have disadvantages, however. For example, the full pressure of the ink fluid stored in the respective ink chambers always places a load on the sieve functioning as an ink outlet. The consequence of this is that the ink tanks sooner or later overflow in an undesired manner. As is described in EP 0 580 433 A1, it is already state of the art to obtain a suitable method for retaining inks by means of two different tanks in one cartridge, employing three different pressure states: on the one hand, a tank containing ink, and on the other hand, two sponges in another container, which provide different ink uptake capacities.

Proceeding from the named prior art, the problem that is the basis of the present invention is to form an ink tank of the type named initially, such that the described disadvantages can be prevented. In particular, an ink tank will be provided, in which the ink chamber can be filled with as much ink as possible, while simultaneously an undesired overflow of ink can be prevented.

This problem is solved according to the invention by an ink cartridge with the features according to the independent patent claim 1. Further features and details of the invention can be taken from the subclaims, the description and the drawing.

According to the present invention, a solution is provided of how an underpressure system can be created in an ink tank, i.e., an ink cartridge, in a particularly simple way. This underpressure system can be manufactured, for example, by modifying a sponge cartridge or an underpressure cartridge that is already in use. According to the present invention, in addition to the ink tank, a suitable method for a corresponding modification is also provided. Features and details, which are described in connection with the ink tank according to the invention, of course, apply also in connection with the modification method described below, and vice versa. Of course, a corresponding underpressure system can also be manufactured by producing it in a new ink tank, i.e., a new ink cartridge.

Particularly utilized in the present invention is the interplay among different phenomena, such as, for example, the law of connected vessels, the retaining of liquids by means of underpressure, the capillary effect, the slowing down of flow velocity due to different elements, and last but not least, also the gravitational force.

According to the invention, an ink tank is provided, in particular for a printing head of an inkjet printer, having an ink chamber for the uptake of ink, the chamber having a removal opening for the ink, having an element for slowing down the outflow of ink, which is provided in the region of the removal opening in the ink chamber and which forms an ink outlet, at least in regions, having a tank element that is provided inside the ink chamber, whose inside space is connected to the ink chamber by means of at least one transfer opening and in which a porous material is provided, and having a ventilation device for the tank element. The ink tank is characterized according to the invention in that at least the ink outlet, which is formed by the element for slowing down the outflow of ink and which is distanced from the removal opening, is provided inside the ink chamber, in that the tank element is disposed at least around the ink outlet formed by the element for slowing down the outflow of ink, in that the porous material is applied at least to the ink outlet formed by the element for slowing down the outflow of ink, and in that the transfer point for ink from the ink chamber into the tank element, which point is formed by the transfer opening, is provided underneath the ink outlet formed by the element for slowing down the outflow of ink.

The present invention is directed to an ink tank, which particularly involves an ink cartridge. Such an ink tank can be specified in particular for a printing head of an inkjet printer.

The ink tank first of all has an ink chamber for the uptake of ink. The ink chamber will be/is filled with ink and preferably represents an indirectly ventilated space. The ink chamber provides a removal opening, by means of which the ink can be delivered to the outside, for example, to the printing head of an inkjet printer.

In addition, an element for slowing down the outflow of ink is provided, which slows down the outflow of ink to a suitable extent. This element is provided in the ink chamber in the region of the removal opening and forms an ink outlet, at least in regions. The present invention is not limited to specific embodiments for such an element. Preferably, such an element can be a sieve or a filter, whereby at least the ink outlet formed by the element for slowing down the outflow of ink is then advantageously designed as a sieve or a filter. Advantageous, but non-exclusive examples for the configuration of such elements will be explained in more detail in the further course of the description.

In addition, the ink tank makes available another tank element, which is provided inside the ink chamber. The inside space of this second tank element is connected to the ink chamber via at least one transfer opening. In this way, it is advantageously provided that the ink chamber and the tank element are connected together via the transfer opening according to the physical principle of connected vessels. This physical principle states that liquid must overall be at the same level in connected vessels.

A porous material is found in this additional tank element inside the ink chamber. The invention is not limited to specific materials in this respect. It is advantageously provided that the porous material is provided in the form of a capillary unit, particularly as a sponge unit. The porous material is preferably provided only in the form of a single unit.

The additional tank element containing the porous material found therein particularly serves for slowing down the flow velocity, as a pressure-compensation vessel, and for ventilation of the remaining space of the ink tank, in particular the ink chamber. The porous material thus acts for ventilation. Its storage effect and its slowing down effect are also utilized simultaneously.

Lastly, the ink tank also has a ventilation device for the tank element. In this case, the invention is not limited to specific configurations of such a ventilation device. In this respect, several advantageous, but non-exclusive examples will be described below.

It can be advantageously provided that the tank element has a ventilation opening. This ventilation opening, for example, can be connected to a ventilation opening in the ink chamber, preferably via a ventilation tube. The ventilation opening in the ink chamber then does not serve for ventilation of the ink chamber itself, but rather it is connected to the ventilation opening of the tank element. If this involves two different ventilation openings, these are preferably joined together via a ventilation tube.

The present invention is not limited to specific embodiments for such a ventilation tube. In the simplest case, the ventilation tube can go straight up. Other embodiments, however, are also conceivable. For example, the ventilation tube may also proceed upward in the form of a spiral or also several loops. Such a configuration, for example, in the transport of a portable printer with a corresponding ink cartridge, can prevent ink from being able to rise to the top through the vent, if the device is turned upside down.

Configurations are also conceivable, however, in which the additional tank element is extended up to the wall of the ink chamber, for example, up to a cover of the ink chamber. In this case, the two ventilation openings could be present in the form of a single ventilation opening, and a ventilation tube could be dispensed with. At the top, the tank element advantageously is only opened far enough to serve for the ventilation of the ink tank up to the wall of the ink chamber, for example, the cover. For example, an opening serving for ventilation can be introduced in the cover itself, or the tank element can be extended through the cover.

The present invention is not limited to specific configurations for the additional tank element. It is advantageously provided that the tank element only occupies a small volume inside the ink chamber. It is preferably provided that the size ratio of the ink chamber to the tank element is greater than 3:1, preferably greater than 4:1. In the ink tank according to the invention, it is possible to reach ratios of more than 3:1, i.e., to accommodate more ink in a larger ink chamber, and also, to configure the space for the tank element smaller in this ratio, this tank element also taking over the function of a type of slowing-down chamber.

For example, the tank element may have tank element boundaries that form the boundary of the inside space of the tank element, in which the porous material is found. A tank element boundary may be designed, for example, as a cover element. The ventilation opening is advantageously found in this cover element. Another tank element boundary may be designed, for example, as a bottom element. The transfer opening between ink chamber and tank element is advantageously found in this bottom element. This transfer opening represents the transfer point of the ink from the ink chamber into the tank element. Configurations are also conceivable, of course, in which one or both of the above-named openings are disposed or designed in a side wall of the tank element.

The transfer opening can be formed advantageously in a boundary wall that bounds the inner space of the tank element. In another configuration, the transfer opening can represent a boundary surface bounding the inner space of the tank element. If the transfer opening is formed, for example, in the bottom element, the transfer opening could extend advantageously over the entire surface of the bottom element, so that a self-contained bottom element is not provided, but instead of this, only a bottom boundary surface that is formed by the transfer opening. The tank element is thus designed as a space that is open toward the bottom. The opening, or the transfer opening, can advantageously lie in the direction of the removal opening.

The tank element can be supported advantageously via support members inside the housing of the ink chamber.

The ink tank according to the present invention has a number of advantages. In the prior art according to EP 0 580 433 A, for example, the use of two sponges with different ink uptake capacities is necessary, in which the upper sponge can take up less ink than the lower sponge. In this way, the law of connected vessels is slowed down toward the top by the increased slowing down effect of the upper sponge. In contrast, in the ink tank according to the invention, only one element of porous material is necessary. In addition, an additional reduction in pressure, for example, due to the relieved ventilation tube is created by the ventilation device of the tank element, and this reduction particularly contributes to creating a chamber ratio of more than 3:1. Another advantage of using only one unit of porous material, instead of two different sponges, lies in the fact that the porous material, as will be explained further in more detail below, can run out freely into the ink chamber. This is supported by a transfer point that is as large as possible. Also, in the prior art, the pressure is increased by the use of two sponges that take up the ink differently, whereby the upper sponge can store less ink. This increased pressure, in contrast, would negatively affect function in the case of a small tank element as is used in the present invention.

It is preferably provided that the ventilation opening is designed to lie opposite the transfer opening.

It is provided according to the invention that at least the ink outlet, which is formed by the element for slowing down the outflow of ink and which is distanced from the removal opening, is provided inside the ink chamber. This means that this element is disposed in the ink chamber in such a way that at least the ink outlet formed by this element is found above the removal opening.

In addition, it is provided according to the invention that the tank element is disposed at least around the ink outlet formed by the element for slowing down the outflow of ink. This can be carried out in different ways. For example, it can be provided that at least the ink outlet formed by the element for slowing down the outflow of ink is provided within the inside space of the tank element, or at the level of a tank element boundary that bounds the inside space of the tank element, or at the level of the transfer opening inside the transfer opening. This tank element, which can be designed, for example, as a type of envelope, is thus introduced around the element that slows down the outflow of ink in a suitable way, this tank element separating a space above the slowing-down element from the remaining space of the ink chamber, of the ink tank, for example, up to the wall of the ink chamber, i.e., up to the cover. This tank element reaches down at least to the level of the element slowing down the outflow of ink in a suitable way, or advantageously even somewhat thereunder, but leaves a suitable connection, preferably at the bottom, so that the ink can flow in a suitable way between the two spaces that form in the ink tank.

In addition, it is provided according to the invention that the porous material is applied at least to the ink outlet formed by the element for slowing down the outflow of ink. This means that the porous material, for example, the sponge unit, is placed directly on the element, or on the ink outlet, respectively, and also optionally surrounds the latter.

According to the invention, the transfer point of ink from the ink chamber into the tank element, this point being formed by the transfer opening, is provided underneath the ink outlet formed by the element for slowing down the outflow of ink. This means that the transfer point between the ink chamber and the tank element, or the porous material, respectively, lies inside the tank element, beneath the ink outlet, for example, a sieve. It is preferably provided that the transfer point of ink from the ink chamber into the tank element, which point is formed by the transfer opening,—seen from the direction of the removal opening or the plane in which the removal opening lies,—is provided underneath the ink outlet formed by the element for slowing down the outflow of ink.

It is preferably provided that the transfer point of ink formed by the transfer opening has a diameter greater than 5 mm. It is advantageously provided that the transfer point is essentially greater than 5 mm. By using a larger transfer point, it is further made possible that the unit made of porous material can run out freely into the ink chamber. A smaller transfer point would mean that the porous material would have to be compressed. A larger transfer point, as is used in the present invention, in contrast, allows the material to be uncompressed.

In the ink tank according to the invention, in the space of the tank element above the ink outlet formed by the element for slowing down the outflow of ink, for example, a sieve, through which the ink is delivered for the printing process, the ink is physically held by a porous material, for example, a sponge, and only delivered in a way that is very greatly slowed down. The entire remaining space of the ink tank or the ink chamber, respectively, is filled with ink. According to the law of connected vessels, a pressure compensation now occurs between the tanks, whereby, with an increasing outflow of ink from the ink chamber into the tank element, an underpressure arises in the remaining space of the cartridge. If the underpressure is too high, the cartridge is ventilated independently and to a suitable degree by the porous material and thus the underpressure is again reduced. Since the transfer point of the ink lies between the two spaces underneath the ink outlet, the pressure from the ink chamber does not directly bear on the ink outlet. At the same time, the underpressure that arises reduces the gravitational force of the ink acting on the porous material.

The ink must therefore flow from the free space of the ink tank upward into the space containing the porous material. And this results according to the law of connected vessels and by capillary effect, while the slowing down effect of the porous material prevents the uncontrolled delivery of ink.

Preferably, the element for slowing down the outflow of ink is designed in a way that the ink cannot overflow past this element and out the removal opening. The invention is not limited to specific embodiments in this respect. It is only important that the element will be/is fastened in a suitable way above the removal opening, so that it is not possible for the ink to overflow past it through the removal opening. For example, but not exclusively, it may be provided that the element for slowing down the outflow of ink is designed in the shape of a sleeve, that the side walls of the element are impermeable to liquid and surround the removal opening of the ink chamber, that a first end of the element is connected to the removal opening, and that the second end lying opposite the first end has or forms the region formed as the ink outlet.

In another configuration, it is advantageously provided that the porous material which is found in the tank element and which is advantageously designed as a single unit and is disposed in the tank element, extends from the tank element into the ink chamber via the transfer opening. Therefore, the porous material can run out freely into the ink chamber. Advantageously, the porous material thus extends outside the transfer opening into the free space of the ink chamber. In this way, it can preferably be provided that the porous material extends downward or in the direction of the removal opening. Advantageously, the porous material can extend into the region between tank element and removal opening of the ink chamber. For example, when the run-out of porous material, for example, a sponge, is found in the bottom region of the ink chamber, the ink pressure will be partially also taken up by the porous material.

The solution according to the invention in particular makes possible the use of an underpressure system in an ink tank, e.g., an ink cartridge, whereby a new or a used housing can serve as the basis, since it does not matter whether it is obtained by means of modifying an ink cartridge with a sponge system or from an ink cartridge with another type of underpressure system. The cartridge can equally well be converted from an already used cartridge in a recycling process.

If a corresponding ink cartridge with underpressure system will be produced, it can be carried out by a suitable modification method. Such a modification method will be described in greater detail below. In this context, in order to explain the course of the method, reference will be made to the full extent to the above statements relative to the ink tank. The method associated therewith is advantageously represented as follows:

The ink cartridge is to be opened in a suitable way, which, of course, can be omitted in the case of a new cartridge. The ink cartridge can be opened, for example, by: Breaking it up into different components, partial opening of the cartridge and unfolding, or the like.

Any ventilation systems in the cartridge, which were necessary for an existing underpressure system, are to be optionally sealed, which, of course, can be dispensed with in the case of a new cartridge. For example, this process can be conducted by means of an adhesive compound, a sealing compound, the introduction of a suitable sealing plate—either from the inside or also from the outside—, employing a suitable heat source that thermally seals the ventilation, use of a suitable ultrasonic technique, use of other suitable sealing techniques, use of mechanical components whereby the ventilation at this site is overridden, or the like.

Optionally, all elements that stand in the way of a conversion into the new underpressure system or reduce the space in the cartridge are to be removed from the ink cartridge, unless they are additionally necessary due to their function. This step can be omitted, of course, in the case of a new cartridge.

Above the outflow opening, which involves the removal opening, an element is to be inserted that slows down the outflow of ink to a suitable extent, for example, a sieve or filter. This element is to be fastened in a suitable manner above the removal opening, so that it is not possible for the ink to flow past it through the removal opening.

An envelope in the form of another tank element, which separates a space above the element that slows down the outflow of ink in a suitable way from the remaining space of the cartridge up to the cover, is to be introduced around this element. This envelope extends out downward beyond the level of the element that slows down the outflow of ink in a suitable manner, but leaves a suitable connection at the bottom, so that the ink can flow in a suitable manner between the two spaces that are formed in the cartridge.

Toward the top up to the cover, the element is only opened far enough to serve for ventilation of the system. An opening serving for ventilation can be introduced in the cover itself or the envelope can be extended through the cover.

A porous element that fills the space, which is preferably in the form of a single unit and which extends under the opening into the free cartridge space, is to be introduced in the envelope. This element serves for slowing down the flow velocity, acts as a pressure-compensation vessel and for ventilation for the remaining cartridge space.

The ink cartridge is to be sealed in a suitable way, so that ink cannot leak out either in use or in transport, nor can pressure changes result in the cartridge due to the seal itself. For example, this step can be carried out by means of an adhesive compound, a sealing compound, the introduction of suitable components from the inside and/or from the outside, employing a suitable heat source for the thermal bonding of the materials, use of a suitable ultrasonic technique, use of other bonding techniques, use of other mechanical components, or the like.

The filling of the ink cartridge with ink suitable for the specific use can take place even before the sealing of the cartridge. The filling may also be conducted, however, after the seal has been introduced. For this purpose, an opening is to be introduced either into the cartridge or the cover, through which the ink is introduced. This filling opening must then absolutely be sealed again. The filling can be provided, however, also through the ventilation opening that is already present in the cartridge.

The invention will now be explained in more detail based on an embodiment example with reference to the attached drawing. Here, the single FIGURE shows in schematic view a cross section through an ink tank according to the invention.

An ink tank 10 that will involve an ink cartridge for a printing head of an inkjet printer is shown in the FIGURE. The ink tank first of all has an ink chamber 11 bounded by a housing 16, the ink chamber 11 representing a space that is not directly ventilated. Ink 12 is found in ink chamber 11. When ink 12 is removed through a removal opening 14, a region 13 is formed in ink chamber 11, in which an underpressure builds up.

In addition, a tank element 30 is provided in ink chamber 11. The size ratio of the ink chamber 11 relative to tank element 30 is preferably greater than 3:1. The tank element 30 has side walls 31, a tank element cover 32 and a tank element bottom 33. A ventilation device is provided for the tank element 30. For this purpose, the tank element 30 first of all provides a ventilation opening 34, which is disposed or formed in tank element cover 32. In addition, a ventilation opening 15 is also provided in housing 16 of ink chamber 11. Both ventilation openings 15, 34 are joined together via a ventilation tube 35 in such a way that a ventilation of the tank element 30 can take place, but without directly ventilating the remaining ink chamber 11.

The inner space 38 of the tank element 30 is connected to ink chamber 11 via a transfer opening 36. In the example shown, the transfer opening 36 is formed in the bottom element of the tank element 30 and thus on the side lying opposite to that where the ventilation opening 34 is found. This transfer opening 36 represents the transfer point 37 of ink from the ink chamber 11 into the tank element 30. It advantageously has a diameter of more than 5 mm.

A porous material 40 in the form of a sponge element is found in the tank element 30, whereby the porous material 40 additionally also extends under the transfer opening 36 into the free space of ink chamber 11.

In addition, an element 20 is provided for slowing down the outflow of ink, this element being formed as a sieve in the example shown. Element 20 is formed in the shape of a sleeve and has a liquid-impermeable side wall 21. With one end 22, element 20 is placed above removal opening 14. The other end 22* projects into the inside space 38 of tank element 30. This end 23 is formed as the ink outlet. * sic; other end 23?—Translator's note.

Thus, the element 20, which slows down the outflow of ink in a suitable manner and is formed as a sieve or filter, is found above the removal opening 14. This element 20 is fastened in a suitable manner above the removal opening 14, so that it is not possible for the ink to flow past it through the removal opening.

An envelope in the form of the tank element 30 is introduced around element 20, which slows down the outflow of ink in a suitable manner, or forms the region 23 that forms the ink outlet, this tank element 30 separating a space 38 above the ink outlet from the remaining space of ink chamber 11 up to housing 16, for example, a cover. This tank element 30 extends downward at least to the level of the element 20 that slows down the outflow of ink in a suitable way or the region 23 thereof that forms the ink outlet 23, but leaves a suitable connection at the bottom 33 in the form of transfer opening 36, so that the ink can flow in a suitable way between the two spaces that form in the cartridge. Toward the top, the tank element 30 is only opened far enough up to housing 16 of ink cartridge 10 to serve for the ventilation of the system. An opening 15 that serves for ventilation is introduced into housing 16 itself.

In tank element 30, the porous material 40 filling the inside space 38 of the tank is found in the form of a sponge element, which extends under opening 36 into the free cartridge space. This element serves for slowing down the flow velocity, acts as a pressure-compensation vessel and for ventilation of the remaining cartridge space.

The following are used in the ink cartridge 10 according to the invention: the interplay made up of the law of connected vessels, the retaining of liquids by means of underpressure, the capillary effect, the slowing down of the flow velocity by different elements, and last but not least, the gravitational force.

In this way, the ink is physically held by the porous material 40 in the space 38 above the sieve 23, through which the ink is delivered to the printing process, and is only very slowly delivered. The entire remaining space of the ink tank 11 is filled with ink 12. According to the law of connected vessels, a pressure compensation now occurs between the ink chamber 11 and the tank element 30, whereby, with increasing outflow of ink from the ink chamber 11 of the cartridge 10 into the tank element 30, an underpressure arises in the remaining space of cartridge 10. If the underpressure is too high, the cartridge 10 is ventilated independently and to a suitable degree by the porous material 40, and thus the underpressure is again reduced. Since the transfer point 37 of the ink lies between the ink chamber 11 and the tank element 30 underneath the ink outlet 23, the pressure from the ink chamber 11 does not directly bear on the ink outlet 23 or the removal opening 14, respectively. And, since the run-out of porous material 40 is found in the bottom region, the pressure is partially also taken up by the porous material 40. At the same time, the underpressure that arises reduces the gravitational force of the ink acting on the porous material 40.

The ink must therefore flow from the free space of the ink chamber 11 of the cartridge 10 upward into the space 38 containing the porous material 40. And this results according to the law of connected vessels and by capillary effect, while the slowing down effect of the porous material 40 prevents the uncontrolled delivery of ink.

### List of Reference Characters

10 Ink tank (ink cartridge)
11 Ink chamber
12 Ink
13 Region of the ink chamber with underpressure
14 Removal opening
15 Ventilation opening
16 Housing
20 Element for slowing down the outflow of ink (sieve)
21 Side wall
22 End
23 End/Ink outlet
30 Tank element
31 Side wall
32 Tank element cover
33 Tank element bottom
34 Ventilation opening
35 Ventilation tube
36 Transfer opening
37 Transfer point
38 Inside space of the tank element
40 Porous material

1. An ink tank, in particular for a printing head of an inkjet printer, having an ink chamber for the uptake of ink, the chamber having a removal opening for the ink, having an element for slowing down the outflow of ink provided in the region of the removal opening in the ink chamber and forming an ink outlet at least in regions, having a tank element, which is provided inside the ink chamber, the inside space thereof being connected to the ink chamber via at least one transfer opening and in which a porous material is provided, and having a ventilation device for the tank element, is hereby characterized in that at least the ink outlet, which is formed by the element for slowing down the outflow of ink and which is distanced from the removal opening, is provided inside the ink chamber, that the tank element is disposed at least around the ink outlet formed by the element for slowing down the outflow of ink, that the porous material is applied at least to the ink outlet formed by the element for slowing down the outflow of ink, and that the transfer point of ink from the ink chamber into the tank element, the transfer point being formed by the transfer opening, is provided under the ink outlet formed by the element for slowing down the outflow of the ink.

2. The ink tank according to claim 1, further characterized in that at least the ink outlet formed by the element for slowing down the outflow of ink is provided within the inside space of the tank element.

3. The ink tank according to claim 1, further characterized in that the ink chamber and the tank element are connected together via the transfer opening according to the physical principle of connected vessels.

4. The ink tank according to claim 1, further characterized in that at least the ink outlet formed by the element for slowing down the outflow of ink is designed as a sieve or a filter.

5. The ink tank according to claim 1, further characterized in that the tank element has a ventilation opening.

6. The ink tank according to claim 5, further characterized in that the ventilation opening is connected to a ventilation opening in the ink chamber, preferably via a ventilation tube.

7. The ink tank according to claim 5, further characterized in that the ventilation opening is designed to lie opposite the transfer opening.

8. The ink tank according to claim 1, further characterized in that the transfer opening is formed in a boundary wall that bounds the inside space of the tank element or that the transfer opening represents a boundary surface bounding the inside space of the tank element.

9. The ink tank according to claim 1, further characterized in that the element for slowing down the outflow of ink is designed in such a way that the ink cannot flow past this element and out the removal opening.

10. The ink tank according to claim 1, further characterized in that the element for slowing down the outflow of ink is designed in the form of a sleeve, that the side walls of the element are impermeable to liquid and surround the removal opening of the ink chamber, in that a first end of the element is connected to the removal opening and in that the second end lying opposite the first end has or forms the region formed as the ink outlet.

11. The ink tank according to claim 1, further characterized in that the porous material found in the tank element extends out of the tank element via the transfer opening into the ink chamber.

12. The ink tank according to claim 11, further characterized in that the porous material extends into the region between tank element and removal opening of the ink chamber.

13. The ink tank according to claim 1, further characterized in that the porous material is provided in the form of a capillary unit, particularly as a sponge unit.

14. The ink tank according to claim 1, further characterized in that the ink transfer point formed by the transfer opening has a diameter greater than 5 mm.

15. The ink tank according to claim 1, further characterized in that the size ratio of the ink chamber to the tank element is greater than 3:1, preferably greater than 4:1.
